(19) United States
(12) Patent Application Publication
(10) Pub. No.: US 2011/0068115 A1
(43) Pub. Date: Mar. 24, 2011

(54) MEDICATION SUPPORTING APPARATUS AND METHOD

(75) Inventors: Jae Hun CHOI, Daejeon (KR); Myung Eun LIM, Daejeon (KR); Sun Lee BANG, Daejeon (KR); Dae Hee KIM, Daejeon (KR); Soo Jun PARK, Seoul (KR); Seon Hee PARK, Daejeon (KR)

(73) Assignee: Electronics and Telecommunications Research Institute, Daejeon (KR)

(21) Appl. No.: 12/878,596

(22) Filed: Sep. 9, 2010

(30) Foreign Application Priority Data
Sep. 22, 2009 (KR) 10-2009-0089577

(51) Int. Cl. B65G 25/04; B65G 35/00; B65G 47/00

(52) U.S. Cl. 221/1; 198/618; 198/750.1; 198/468.01

(57) ABSTRACT

Provided are a medication supporting apparatus and method. In the medication supporting apparatus, a storage section stores a strip of dosage bags that are continuously connected. A carrier section carries the dosage bag strip in the storage section. A sensor section generates a detection signal detecting a position of the dosage bag strip on the carrier section. A circuit section determines the position of the dosage bag strip according to the detection signal of the sensor section, and controls the carrier section. The dosage bag strip packed in continuous dosage bags is recognized in a unit of one dosage bag, is adjusted to a start position thereof, and is dispensed by a size of one dosage bag, so that the dosage bag strip can be accurately dispensed.

### CROSS-REFERENCE TO RELATED APPLICATION

This application claims priority to and the benefit of Korean Patent Application No. 10-2009-0089577, filed Sep. 22, 2009, the disclosure of which is incorporated herein by reference in its entirety.

### BACKGROUND

1. Field of the Invention

The present invention relates generally to a medication supporting apparatus and, more particularly, to a medication supporting apparatus for supporting periodical medication.

2. Discussion of Related Art

For chronic patients who need to periodically take medicine over a long period of time, it is very important to manage medication.

This is because there is a risk that patients will be treated on the basis of inaccurate information about the medication when they suffer from the failure of memory or have an aversion to a disease.

As such, there is a need for a technique of supporting systematic the medication.

In the case of a conventional smart medicine box, a technique of setting an alarm for a medication time to take the medicine has been applied. This indicates the medication time to a patient by raising an alarm when a preset time arrives.

Recently, prescription medicine has been air-tightly packed in paper dosage bags of, for instance, for sanitary reasons, and is provided so as to allow the dosage bags to be separated from each other one by one. The smart medicine box simply stores the dosage bags in which the medicine is contained, and functions to sound an alarm at the medication time.

Meanwhile, to accurately monitor a user who takes the medicine contained in the dosage bag separated from the continuous dosage bags, the smart medicine box must be allowed to recognize and dispense the dosage bags one by one. The dosage bag generally has a fixed size. However, when the medicine is actually packed, the size of the dosage bag may vary within a predetermined size range. As a result, the smart medicine box has an error in recognizing the size of the dosage bag. When such an error is accumulated, it is difficult for the smart medicine box to normally dispense the dosage bags.

### SUMMARY OF THE INVENTION

The present invention is directed to a medication supporting apparatus that accurately recognizes continuous dosage bags in a unit of one dosage bag and dispenses the dosage bags one by one.

An aspect of the present invention is to provide a medication supporting apparatus, which includes: a storage section storing a strip of dosage bags that are continuously connected; a carrier section carrying the dosage bags in the storage section; a sensor section generating a detection signal detecting a position of the dosage bag strip on the carrier section; and a circuit section determining the position of the dosage bag strip according to the detection signal of the sensor section and controlling the carrier section.

In exemplary embodiments, the carrier section may include a conveyer belt on which the dosage bag strip is placed, and a motor moving the conveyer belt in a forward or backward direction.

In exemplary embodiments, the sensor section may include an upper electrode, and a lower electrode coming into contact with the upper electrode, and the dosage bag strip may move between the upper electrode and the lower electrode in a forward or backward direction.

In exemplary embodiments, the detection signal may include information about contact or non-contact between the upper electrode and the lower electrode according to the position of the dosage bag strip.

In exemplary embodiments, the circuit section may control the motor according to the detection signal, and recognize a start position of the dosage bag strip.

In exemplary embodiments, the medication supporting apparatus may further include a fixture section connected with the sensor section and fixing movement of the dosage bag strip.

In exemplary embodiments, the fixture section may include a tear-off plane for tearing the dosage bag strip dispensed in an outward direction.

In exemplary embodiments, the medication supporting apparatus may further include a medication button for checking administration of medicine contained in the dosage bag separated from the dosage bag strip.

In exemplary embodiments, the medication supporting apparatus may further include a telecommunication section sending information about the administration of medicine when the administration of the medicine is confirmed.

Another aspect of the present invention is to provide a medication supporting method, which includes: releasing a fixture of a strip of dosage bags that are continuously connected; determining a present position of the dosage bag strip; moving the dosage bag strip to recognize a start position of the dosage bag strip as a result of the determination; moving the dosage bag strip from the start position of the dosage bag strip by a size of one dosage bag, and dispensing the dosage bag; and fixing the dosage bag strip to separate the dispensed dosage bag.

In exemplary embodiments, determining the present position of the dosage bag strip may include reading a detection signal detecting whether or not the dosage bag strip is interposed between upper and lower electrodes.

In exemplary embodiments, moving the dosage bag strip to recognize the start position of the dosage bag strip may include: if the dosage bag strip is not interposed between the upper and lower electrodes according to the detection signal, moving the dosage bag strip forward between the upper and lower electrodes; and if the dosage bag strip is interposed between the upper and lower electrodes according to the detection signal, moving the dosage bag strip backward to dispose the dosage bag strip on a tear-off plane of a fixture section between the upper and lower electrodes.

### BRIEF DESCRIPTION OF THE DRAWINGS

The above and other features and advantages of the present invention will become more apparent to those of ordinary skill in the art by describing in detail preferred embodiments thereof with reference to the attached drawings in which:

FIG. 1 illustrates the configuration of a medication supporting apparatus according to an exemplary embodiment of the present invention;

FIG. 2 is an enlarged view illustrating the sensor section of FIG. 1;

FIG. 3 is a flowchart for explaining the operation of a medication supporting apparatus according to an exemplary embodiment of the present invention; and

FIGS. 4A and 4B illustrate a configuration of one example of the flowchart of FIG. 3.

### DETAILED DESCRIPTION OF EXEMPLARY EMBODIMENTS

The present invention will be described more fully hereinafter with reference to the accompanying drawings, in which exemplary embodiments of the invention are shown. This invention may, however, be embodied in different forms and should not be construed as limited to the embodiments set forth herein. In order to keep the following description of the present invention clear and concise, detailed descriptions of known functions and components may be omitted. When any element of the invention appears in more than one drawing, it is denoted by the same reference numeral in each drawing.

It will be understood that, throughout the specification, unless explicitly stated to the contrary, the term “comprise” and its conjugations such as “comprises” and “comprising” should be interpreted as including any stated elements but not necessarily excluding other elements. In addition, the terms “section,” “device,” and “module” used herein refer to a unit which can be embodied as hardware, software, or a combination thereof, for processing at least one function and performing an operation.

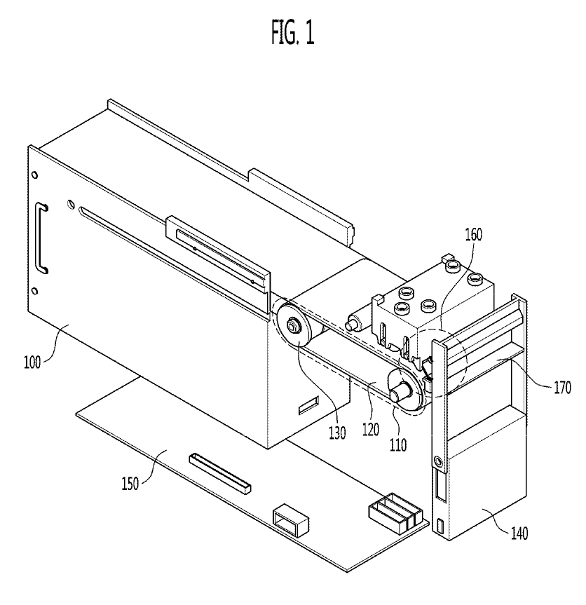

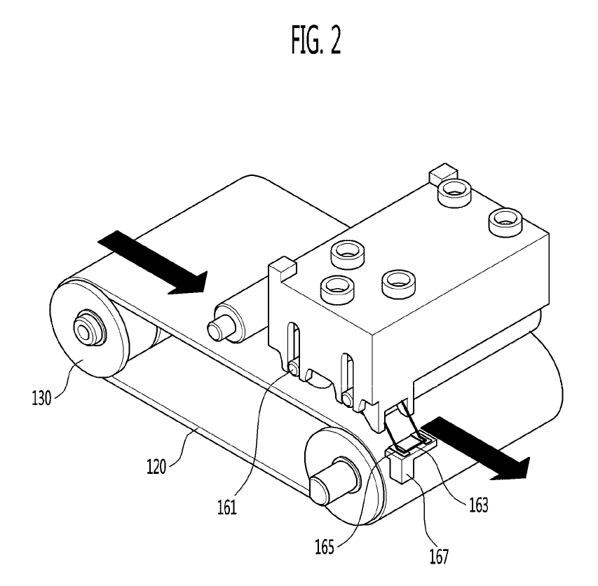

Hereinafter, a medication supporting apparatus according to an exemplary embodiment of the present invention will be described with reference to FIGS. 1 and 2.

FIG. 1 illustrates the configuration of a medication supporting apparatus according to an exemplary embodiment of the present invention, and FIG. 2 is an enlarged view illustrating the sensor section of FIG. 1.

Referring to FIG. 1, a medication supporting apparatus according to an exemplary embodiment of the present invention includes a storage section 100, a carrier section 110, a sensor section 160, a fixture section 140, and a circuit section 150.

The storage section 100 stores dosage bags, each of which is made of paper and contains a dosage of medicine, so as to be sequentially dispensed one by one. This storage section 100 includes a cover door, which is opened forwardly or upwardly. The dosage bags are stored in the storage section 100 through the cover door.

The dosage bags are stored in the storage section 100 in a rolled or folded state, and the stored dosage bags are continuously connected with no intermediate disconnection.

A dispensing port of the storage section 100 is connected with the carrier section 110.

The carrier section 110 includes a conveyer belt 120 and a motor 130. When the motor 130 is driven, the conveyer belt 120 moves. Thereby, the dosage bags placed on the conveyer belt 120 are carried.

Here, the conveyer belt 120 may move forward or backward depending on a rotational direction of the motor 130.

An end of the conveyer belt 120 of the carrier section 110 is connected with the sensor section 160.

The sensor section 160 is configured as shown in FIG. 2.

Referring to FIG. 2, the sensor section 160 includes a plurality of rollers 161 moving the conveyer belt 120, as well as a support 167, an upper electrode 163, and a lower electrode 165 at one end of the conveyer belt 120.

The lower electrode 165 is formed on the support 167, and the upper electrode 163 has a loop shape, and is bent so as to come into contact with the lower electrode 165.

When the upper electrode 163 and the lower electrode 165 come into contact with each other, a current flows. Thereby, the sensor section 160 sends a detection signal. When the dosage bag is interposed between the upper electrode 163 and the lower electrode 165, the contact between the upper electrode 163 and the lower electrode 165 is interrupted. In this case, no current flows, and the sensor section 160 sends no detection signal.

Thus, it is possible to determine whether or not the dosage bag is interposed between the upper electrode 163 and the lower electrode 165 on the basis of the sent detection signal.

Meanwhile, when the dosage bags are correctly dispensed one by one through the sensor section 160, a fixture section 140 fixes one end of each dosage bag, and induces each dosage bag to be torn and dispensed through a tear-off plane 170.

The circuit section 150 generates and sends control signals for controlling driving of the sensor section 160, the motor 130, and the fixture section 140. The circuit section 150 may be configured of a printed circuit board (PCB), and may include a telecommunication section (not shown) and a medication button (not shown).

With the telecommunication section, when a user, i.e. a patient, takes the medicine packed in the dosage bag that has been torn and dispensed, and then pushes the medication button, it is possible to send the user's medication to an external monitoring apparatus.

In this manner, due to the medication button and the telecommunication section, a medication schedule of the patient is managed in cooperation with the external monitoring apparatus, so that the medication can be supported through remote control. This monitoring apparatus may include terminals of a hospital, a nursing home, and a caregiver.

Further, the circuit section 150 sets an administration time, controls dispensing of the dosage bags at the set administration time, and alarms the user through a sound when the dosage bag is dispensed, so that it can inform the user of the administration time.

In the medication supporting apparatus shown in FIGS. 1 and 2, the circuit section 150 controls the motor 130 and the sensor section 160 in order to accurately tear and dispense the dosage bags one by one.

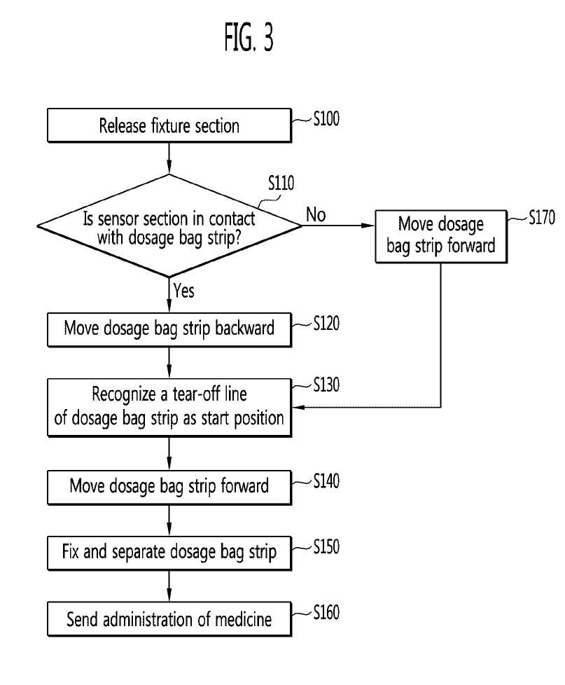

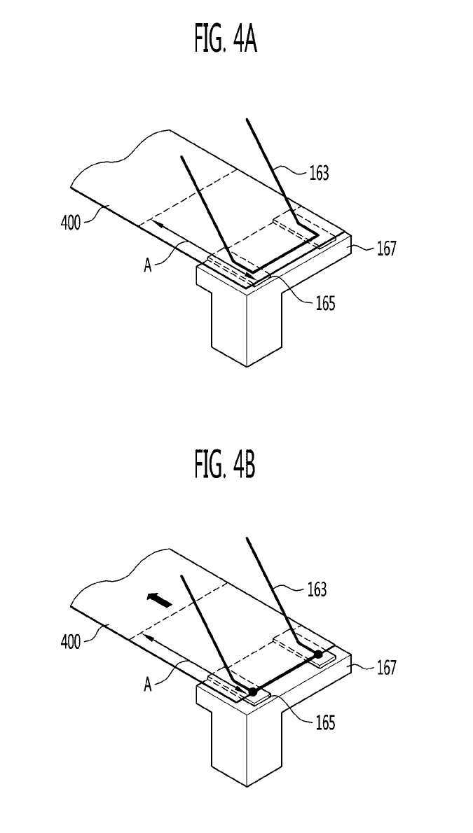

Hereinafter, the operation of a medication supporting apparatus according to an exemplary embodiment of the present invention will be described with reference to FIGS. 3 and 4.

FIG. 3 is a flowchart for explaining the operation of a medication supporting apparatus according to an exemplary embodiment of the present invention, and FIGS. 4A and 4B illustrate a configuration of one example of the flowchart of FIG. 3.

Referring to FIG. 3, when an administration time set for the circuit section 150 arrives, the fixture section 140 is released, and thus a strip of dosage bags is allowed to move (S100).

Next, a detection signal of the sensor section 160 is read to check whether or not the dosage bag strip is interposed between the upper and lower electrodes 163 and 165 of the sensor section 160 (S110).

As in FIG. 4A, when the dosage bag strip 400 is interposed between the upper and lower electrodes 163 and 165 and thus no current flows, the detection signal is read to check a present situation, and then the motor 130 is driven to move the dosage bag strip 400 in a backward direction (S120).

The dosage bag strip 400 continues to move backward until the upper and lower electrodes 163 and 165 come into contact with each other. When the upper and lower electrodes 163 and 165 come into contact with each other, the circuit section 150 stops driving the motor 130, and a position where the dosage bag strip 400 is located at present is set to a start position of the dosage bag strip 400 (S130).

When the start position of the dosage bag strip 400 is recognized, the circuit section 150 drives the motor 130 so as to rotate forward, and the dosage bag strip 400 is moved by a size A of one dosage bag thereof. Thereby, the dosage bag is dispensed (S140).

Here, the size A of one dosage bag of the dosage bag strip 400 is previously set for the circuit section 150.

When one dosage bag of the dosage bag strip 400 is dispensed, the circuit section 150 drives the fixture section 140 to fix the dosage bag, and alarms the user that the dosage bag is dispensed so as to remind the user to take the medicine (S150).

When the user takes the medicine, which is contained in the dosage bag of the dosage bag strip 400 torn through the tear-off plane 170 of the fixture section 140, and then pushes the medication button, the telecommunication section sends the medication of the user to the external monitoring apparatus.

Meanwhile, in the case where the dosage bag strip 400 is not interposed between the upper and lower electrodes 163 and 165 when the fixture section 140 is released to read the detection signal, the circuit section 150 drives the motor 130 so as to rotate forward, thereby moving the dosage bag strip 400 forward to a position where the current of the detection signal does not flow (S170).

When no current flows between the upper and lower electrodes 163 and 165, the start position of the dosage bag strip 400 is recognized, and thus the dosage bag strip 400 is moved by the size A of the dosage bag thereof. Thereby, the dosage bag of the dosage bag strip 400 is dispensed.

As described above, the present position of the dosage bag strip 400 is recognized through the electrodes 163 and 165 of the sensor section 160, and is adjusted to the start position, so that a dispensing error of the dosage bag strip 400 can be prevented.

According to exemplary embodiments of the present invention, a dosage bag strip packed with continuous dosage bags is recognized in a unit of one dosage bag, is adjusted to a start position thereof, and is dispensed by a size of one dosage bag, so that the dosage bag strip can be accurately dispensed.

Thus, it is possible to reduce a dispensing error of the dosage bag. The medication button is pushed after the dosage bag is dispensed and separated, and information about administration of medicine is sent, so that the administration of medicine can be monitored outside.

The exemplary embodiment of the present invention described above can also be implemented as a computer program, or as a recording medium on which a computer program is recorded. This will be easily implemented from the disclosure of the above-mentioned exemplary embodiments of the present invention by those skilled in the art.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. A medication supporting apparatus comprising:
a storage section storing a strip of dosage bags that are continuously connected;
a carrier section carrying the dosage bags in the storage section;
a sensor section generating a detection signal detecting a position of the dosage bag strip on the carrier section; and
a circuit section determining the position of the dosage bag strip according to the detection signal of the sensor section and controlling the carrier section.

2. The medication supporting apparatus according to claim 1, wherein the carrier section includes:
a conveyer belt on which the dosage bag strip is placed; and
a motor moving the conveyer belt in a forward or backward direction.

3. The medication supporting apparatus according to claim 1, wherein the sensor section includes an upper electrode, and a lower electrode coming into contact with the upper electrode, and
the dosage bag strip moves between the upper electrode and the lower electrode in a forward or backward direction.

4. The medication supporting apparatus according to claim 3, wherein the detection signal includes information about contact or non-contact between the upper electrode and the lower electrode according to the position of the dosage bag strip.

5. The medication supporting apparatus according to claim 2, wherein the circuit section controls the motor according to the detection signal, and recognizes a start position of the dosage bag strip.

6. The medication supporting apparatus according to claim 1, further comprising a fixture section connected with the sensor section and fixing movement of the dosage bag strip.

7. The medication supporting apparatus according to claim 6, wherein the fixture section includes a tear-off plane for tearing the dosage bag strip dispensed in an outward direction.

8. The medication supporting apparatus according to claim 7, further comprising a medication button for checking administration of medicine contained in the dosage bag separated from the dosage bag strip.

9. The medication supporting apparatus according to claim 8, further comprising a telecommunication section sending information about the administration of medicine when the administration of the medicine is confirmed.

10. A medication supporting method comprising:
releasing a fixture of a strip of dosage bags that are continuously connected;
determining a present position of the dosage bag strip;
moving the dosage bag strip to recognize a start position of the dosage bag strip as a result of the determination;
moving the dosage bag strip from the start position of the dosage bag strip by a size of one dosage bag, and dispensing the dosage bag; and
fixing the dosage bag strip to separate the dispensed dosage bag.

11. The medication supporting method according to claim 10, wherein the determining of the present position of the dosage bag strip includes reading a detection signal detecting whether or not the dosage bag strip is interposed between upper and lower electrodes.

12. The medication supporting method according to claim 11, wherein the moving of the dosage bag strip to recognize the start position of the dosage bag strip includes:
if the dosage bag strip is not interposed between the upper and lower electrodes according to the detection signal, moving the dosage bag strip forward between the upper and lower electrodes; and
if the dosage bag strip is interposed between the upper and lower electrodes according to the detection signal, moving the dosage bag strip backward to dispose the dosage bag strip on a tear-off plane of a fixture section between the upper and lower electrodes.

13. The medication supporting method according to claim 10, further comprising, when one dosage bag is separated from the dosage bag strip, detecting administration of medicine contained in the separated dosage bag, and sending the administration of the medicine to an outside.
